(19) United States
(12) Patent Application Publication
(10) Pub. No.: US 2023/0116418 A1
(43) Pub. Date: Apr. 13, 2023

(54) Sensor Centric Datastore for a Customer Information System

(71) Applicant: Badger Meter, Inc., Milwaukee, WI (US)

(72) Inventors: Javey Shahram, Los Gatos, CA (US); Arthur Ryman, Thornhill (CA); Douglas Bergh, Los Gatos, CA (US)

(21) Appl. No.: 17/499,147

(22) Filed: Oct. 12, 2021

(51) Int. Cl. G06Q 50/06; G06F 16/22

(52) U.S. Cl. CPC G06Q 50/06; G06F 16/22

(57) ABSTRACT

A computer-implemented data management system for sensor-centric data management is shown. The management system includes a metering analytics system configured to receive and store meter data received from sensors in or in proximity with utility meters, the meter data being generated by the sensors. The management system further includes a sensor-centric database for storing sensor data according to a sensor identifier, the sensor data describing the sensor associated with the sensor identifier. The database includes a data exchange interface configured to receive a transaction for storage in the sensor-centric database including a record of sensor data and an “assert” or “retract” operation type.

### FIELD OF THE INVENTION

This application relates to sensor data management systems and methods for implementing such systems. More specifically, this application relates to a data management system having a sensor-centric datastore for interacting with utility providers and their customer information systems.

### BACKGROUND

Utility providers use a network of utility meters located at network endpoints, where the utility being provided exits a distribution network and is provided to customers or end users. The flow of the utility being used by the customers or end users is measured and monitored at these utility meters. Automatic meter reading (AMR) systems typically read the individual meters and provide the readings through utility meter radio transmitters operating in a local area network to communicate with radio receivers, often mounted on a rooftop or a utility pole. The receivers also sometimes operate as gateways, for collecting meter data from the transmitters and then transmitting the meter data through a second network to a central office. The meter data is transmitted from the receivers or gateways to the central office to a data management system such that the data can then be used for processing into customer statements of account, etc. Typically, there is at least a network communications computer operating as a meter management system that interfaces with an applications computer at the central office of the local utility that operates as a customer information system (CIS), although various systems at the collection end are possible and are known in the art.

Meter management systems and methods are computer-implemented systems and programs configured to manage data collection and provision of the data to utility CIS for reporting, billing, etc. to be performed by the utility provider. Typically, meter management systems attempt to mirror the data model used by the utility CIS. However, each utility CIS is typically unique to the utility and is also both consumer-centric and complex. In a utility CIS, the top-level entities are consumers, accounts, premises, etc. descending finally down to specific utility meters and/or sensors with the utility meters. Mirroring utility CIS data models is complex because they typically have significant integrity constraints and vary widely between different utility providers. In turn, meter management systems' data management functionality must also become more complex and inflexible to implement the mirroring of the utility CIS data model. This complexity increases the cost and implementation and management difficulty for the meter management system to upload data to the utility CIS in a manner that implements the business rules of the utility and adapts to any changes in those business rules.

What is needed is a meter data management system and method that provides a sensor description datastore and data exchange method that is flexible and cost effective in providing meter data to a variety of constantly adapting utility customer information systems. What is further needed is such a system and method that allows utility provider customer information systems to implement business rules unique to each utility provider.

### SUMMARY OF THE INVENTION

The present invention is directed to a sensor-centric datastore system and method for use in a meter management system that “inverts” the data model, putting meters at the top of the hierarchy, while also remaining neutral to the detailed business rules of the differing customer information system of utility providers. In contrast with previous datastore systems and methods, the system and method of the present application does not recreate the utility CIS business rules, simplifying an integration process without imposing restrictions on the utility business rules.

In one more detailed aspect, a computer-implemented data management system for sensor-centric data management is shown. The management system includes a metering analytics system configured to receive and store meter data received from sensors in or in proximity with utility meters, the meter data being generated by the sensors. The management system further includes a sensor-centric database for storing sensor data according to a sensor identifier, the sensor data describing the sensor associated with the sensor identifier. The database includes a data exchange interface configured to receive a transaction for storage in the sensor-centric database including a record of sensor data and an “assert” or “retract” operation type.

In another embodiment of the invention, a computer-implemented data management system for sensor-centric data management is provided that includes a metering analytics system configured to receive and store meter data received from sensors in or in proximity with utility meters, the meter data being generated by the sensors; and a sensor-centric database for asynchronously storing sensor description data transmitted by a utility data management system according to a sensor identifier, the sensor description data describing the sensor associated with the sensor identifier. The database includes a data exchange interface configured to receive a transaction for storage in the sensor-centric database including a record of sensor description data and an “assert” or “retract” operation type. The sensor description data is utilized by the metering analytics system during communication of the meter data to the utility data management system.

Other aspects of the invention, besides those discussed above, will be apparent to those of ordinary skill in the art from the description of exemplary embodiments which follows. In the description, reference is made to the accompanying drawings, which form a part hereof, and which illustrate examples of the invention.

### BRIEF DESCRIPTION OF THE DRAWINGS

FIG. 1 is a representative diagram of an advanced metering infrastructure (AMI), according to an exemplary embodiment;

FIG. 2 is a sensor-centric datastore system, according to an exemplary embodiment;

FIGS. 3A and 3B are representation of data structures used in the implementation of the sensor-centric datastore of FIG. 2, according to an exemplary embodiment; and

FIG. 4 is a flowchart illustrating a method for implementing the sensor-centric datastore of FIG. 2, according to an exemplary embodiment.

### DETAILED DESCRIPTION OF THE INVENTION

The present application is directed to a utility meter management system configured to interact with a utility customer information system using a sensor-centric datastore and datastore management system and method. The sensor-centric datastore is configured to be organized based on sensors providing data to a meter management system as opposed to being organized based on specific customers, accounts, etc. of a utility provider. The system and method may be used within an advanced metering infrastructure as described in further detail below.

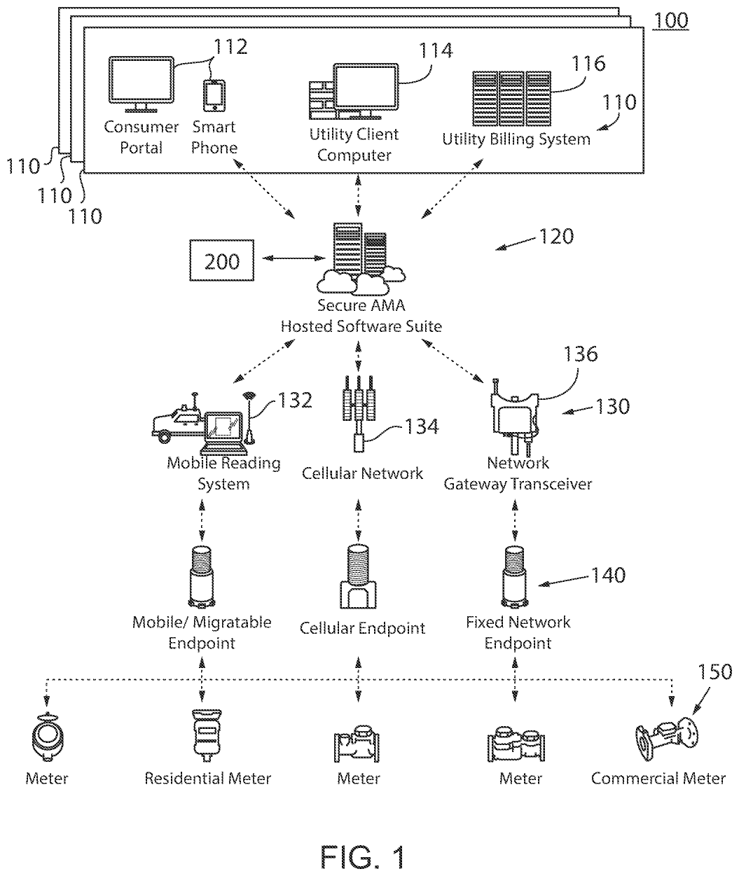

Referring first to FIG. 1, a representative diagram of an advanced metering infrastructure (AMI) 100 is shown, according to an exemplary embodiment. AMI 100 is an integrated system of a plurality of utility data management systems 110, an advanced metering analytics (AMA) system 120, communications networks 130, metering endpoints 140, and utility meters 150 that collectively monitor and communicate meter related data and enable two-way communication between utility providers and utility consumers. AMI 100 provides a number of important functions that were not previously possible or had to be performed manually, such as the ability to automatically and remotely measure utility use, facilitate the operation of consumer information management systems, connect and disconnect service, detect tampering, identify and isolate outages and/or leaks, and monitor utility use.

In one exemplary embodiment, each utility data management system 110 may include consumer portal systems 112, utility client computers 114 and utility billing systems 116. Consumer portal systems 112, utility client computers 114 and utility billing systems 116 may be configured for traditional interactions between utility providers and utility consumers. Consumer portal systems 112 may be configured to provide utility customers with access to their water consumption data, allowing them to view their usage activity and gain a greater understanding and control of the water they consume. Utility billing systems 116 may be configured to provide traditional billing functions based on utility consumption. Utility client computer systems 114 may be configured to implement system management functions, such as to provide the hosted software platform, system maintenance, software support, and management information.

In an exemplary embodiment, each utility data management system 110 is implemented by a single utility provider with their own interfaces, business rules, billing mechanisms, etc. that are unique to that utility provider. Accordingly, each utility data management system 110 will interact with the advanced metering analytics system 120 in a different manner such as frequency of meter data uploads, granularity of meter data uploaded, etc. However, using the present system and method as described herein, such customizations may be implemented within a utility data management system 110 without modifying the analytics system 120. Accordingly, analytics system 120 provides services to multiple utilities, each with their own utility data management system 110 and its associated data model, data integrity constraints, business rules, etc.

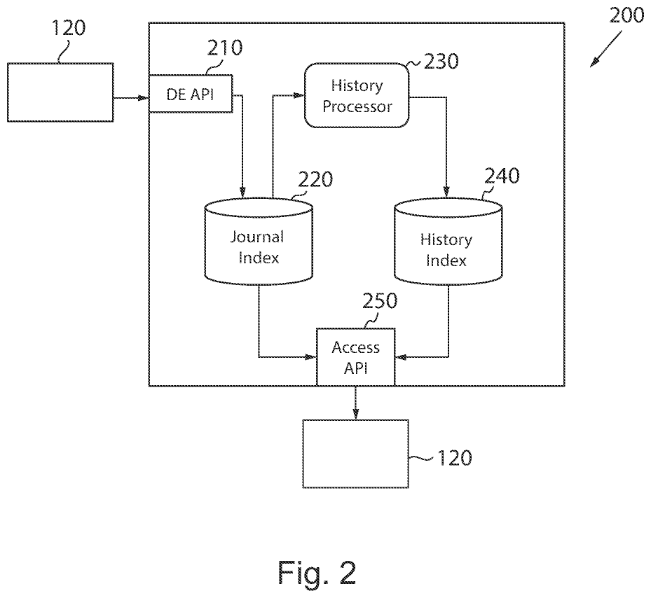

Advanced metering analytics system 120 is a system and method for aggregating utility data collected over communication networks 130 from endpoints 140 in communication with meters 150. System 120 collects meter data for reporting to billing systems 116 and for display through consumer portal systems 112. System 120 further cooperates with client computers 114 to report collected meter data, implement leak detection, and shut off functions for particular meters, etc. In the present invention, system 120 includes a sensor-centric datastore system 200, described below with reference to FIG. 2, and is configured to include a data management system for implementing the sensor-centric datastore.

Communications networks 130 may be one or more of a mobile network 132, a cellular network 134, a fixed network 136, etc. to communicate the meter data from endpoints 140 to analytics system 120. For example, wherein network 130 is a fixed network, fixed network transceiver assemblies are used, as opposed to mobile transceivers carried in a vehicle or carried by a human employed for mobile networks 132 to collect meter data.

Metering endpoints 140 can receive data (e.g., messages, commands, etc.) from meters 150 and transmit meter data or other information to the AMA system 120. Depending on the exact configuration and types of devices used, the endpoint devices 140 transmit standard meter readings either periodically (“bubble-up”), in response to a wake-up signal, or in a combination/hybrid configuration. In each instance, the endpoint devices 140 are configured to exchange data with devices of the analytics system 120 through communication networks 130.

Utility meters 150 are shown as fixed automatic meter reading systems for a water distribution system that include a meter and meter register assembly and/or encoder connected in a water line. The meter register in the assembly can display units of consumption. In one embodiment, the register uses a pulse transmitter to convert the mechanical movements of the meter to electrical signals. An encoder may also be used as a register. In general, an encoder is a device or process that converts data from one format to another and is a device which can detect and convert mechanical motion to an analog or digital coded output signal. Meters 150 may include disc meters, ultrasonic meters, etc. to measure the utility flow through the measuring device as recorded by a register/encoder.

A utility meter may have more than one sensor. Many different types of utility measurement sensors are in widespread use, e.g., electricity, natural gas, oil, water, etc. to measure an amount being provided to a customer. Additional sensors may be associated with the meter and positioned within the body of the meter and/or near the meter within an endpoint location. Exemplary sensors may include, but are not limited to, backflow sensors, leak/moisture detectors, water quality sensors, water valve positioning sensors, pressure sensors, temperature sensors, etc.

Using the system and method, described above, analytics system 120 is configured to maintain a datastore that provides a history of sensor readings and other data, collectively referred to as meter data. The analytics system 120 typically provides this data to the utility data management system 110 associated with the meter for their operations. For example, a water utility provider must bill the consumption for a given time period to the occupant of the premises where the meter is installed for the time period and uses the meter data to do so. Sensor description data may be used to determine how the sensor data is used. Exemplary meter description data can include identification of the premises where the meter is installed, identification of the occupant for billing, identification of the resolution setting of the meter, etc.

However, occupants may change over time and meters may be moved from one premises to another. Accordingly, it is important to understand where a meter is installed and the identity of the occupant for that premises at the time the consumption is reported for the utility data management system 110.

As a further example, water consumption may be reported in terms of unitless pulse counts whose correct translation into volume units requires a knowledge of the resolution setting of the meter. The resolution setting may be changed by the utility provider. Accordingly, utility data management system 110 must know the resolution of the meter corresponding to the time when the pulse count is reported to properly determine an utility amount that was used by a consumer.

Referring now to FIG. 2, a sensor-centric datastore system 200 is shown, according to an exemplary embodiment. Within the datastore system 200, information about the current state of a set of sensors, e.g., water meters, whose state changes over time, referred to herein as sensor description data, is stored. Sensor description data may include data related to a customer account, data related to a premises, data related to a service point, data related to a meter, data related to a district metering area, data related to an endpoint, data related to meter or sensor readings, etc. Datastore system 200 may be implemented as an external system as shown in FIGS. 1 and 2 and described herein or as a component within a larger system, such as advanced metering analytics system 120. The utility data management systems 110 are configured to access both the current state information as well as historical information within datastore system 200, either directly or through communication with analytics system 120.

Datastore system 200 is configured to include a data exchange application programming interface (API) 210, a journal index 220, a history processor 230, a history index 240 and an access application programming interface (API) 250. These interfaces, processors, and indices may be implemented using software and/or hardware within system 200. Data Exchange API 210 is a set of programmed instructions, stored in non-volatile memory, that allow the external analytics system 120 to transmit information to datastore system 200. Journal index 220 includes a datastore and process that stores all the information transmitted to datastore system 200 from the analytics system 120. History processor 230 is another set of programmed instructions, stored in non-volatile memory, that processes the information stored in the journal index 220, computes a history associated with a particular sensor based on the processed information, and stores the processed information in the history index 240. History index 240 includes another datastore for storing the processed histories of the sensors from the journal index 220. The access API 250 enables users and other systems to access the data stored in either of the journal index 220 and the history index 240 through the external analytics system 120. These interfaces, processors, indices are discussed below in further detail.

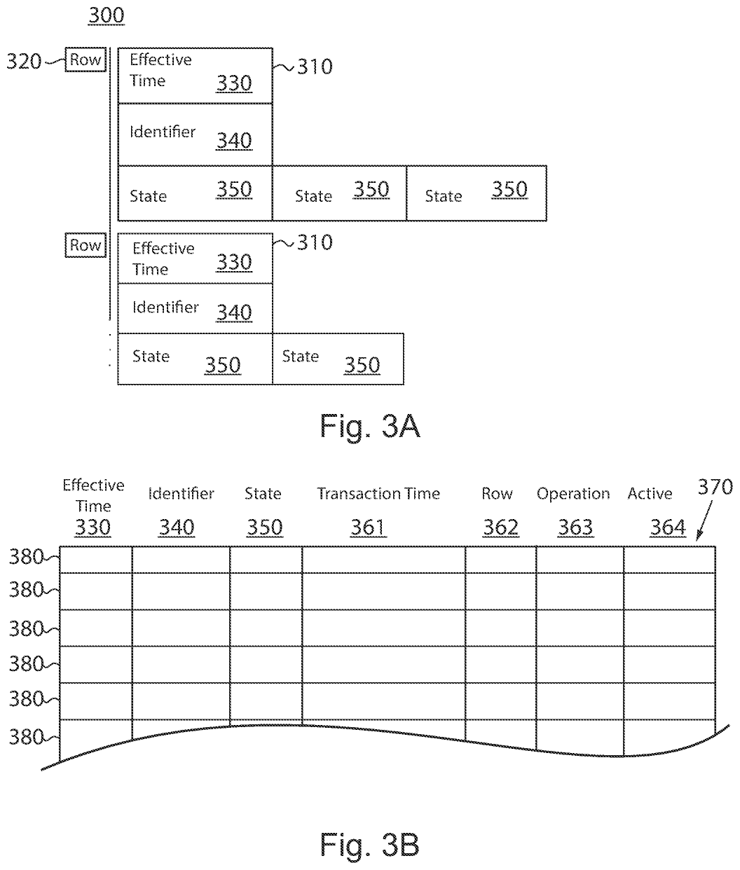

Data exchange API 210 includes a set of operations configured to receive and process meter data and CIS data. The CIS data is received either directly from a system 110 or indirectly through advanced metering analytics system 120 and the data is converted into a datastore data format for storage in journal index 220 as described below. Referring now also to FIG. 3A, the data format defines a record sequence 300 that includes a sequence of records 310 generated based on data received through the API 210, each record 310 including a set of fields, each field including a field name and a field value as further described below. Each record sequence 300 includes a plurality of files 310 having positions 320 for each record 310 within the record sequence 300, referred to as its row number.

Each record 310 comprises a logical tuple of sub-records (Time 330, Identifier 340, State 350). A tuple is a single row of a table and represents a set of related data. Time 330 defines the time of the record, identifier 340 identifies the sensor to which the data in the record pertains, and state 350 includes the state of the sensor. Each of the Time 330, Identifier 340 and State 350 sub-records includes one or more fields having field names and field values.

A record provides the state of the sensor identified at the time indicated in the record in the Time 330 sub-record. The identifier 340 sub-record uniquely identifies an entity within the advanced metering analytics 120 system. For example, in a water utility system, identifier 340 sub-record may include a meter identifier field and a register identifier field. The state 350 sub-record includes data associated with the sensor identified by sensor 340 sub-record. For example, state 350 sub-record may include a premises, a meter resolution, a customer identifier, a billing address, etc.

Advantageously, the datastore system 200 does not feature data integrity constraints on the values with the state 350 sub-record for each record 310. Datastore system 200 delegates the maintenance of data integrity to the systems, such as customer information systems 100 and endpoints 140, that are in communication with system 120. Delegating data integrity maintenance eliminates any potentially unintended data modifications triggered by the enforcement of data integrity rules when datastore system 200 stores data within journal index 220.

For example, in the data received by the advanced metering analytics system 120 from a customer information system 110, a CIS record may include a billing address. The CIS 110 may have a data integrity rule that requires that the CIS 110 only associate a billing address with a premises (i.e., in the record, the billing address must match the address of the premises). This data integrity rule means that every meter at a given premises must have the same billing address since the CIS associates the billing address with the premises and not each individual meter at the premises. However, datastore 200 is configured such that if, for example, a premises has two meters, and the billing address for the premises changes, CIS 110 must transmit update records for both meters. In this case, datastore 200 will update the record for the first of the meters upon receipt of a record for the meter that includes the new billing address. The record for the second of the meters will continue to contain the old billing address until a record for the second meter is received by datastore system 200. By not enforcing any data integrity constraints, datastore system 200 records are simpler and easier to understand. Further, data in datastore system 200 is applicable to both systems that require synchronization between billing address and premises (by the eventual updating of both records) and a CIS 110 that allows individual meters at a premises to have different billing addresses.

In addition to storing data in the journal index 220, DE API 210 is configured to identify where a transmitted data record has a blank time record 330. It is advantageous to not require that each transmitted data record have an explicit time value because, in practice, a utility will set up a data extraction job to run periodically, e.g. hourly, and extract recently modified data records from its systems and transmit them via the DE API 210. In this case, all transmitted data records will be deemed to have the same time value, namely the time at which the DE API is called. Time 330 sub-record may be optionally provided via the DE API 210. It is advantageous to allow the time value to be explicitly provided via the DE API in the case where a previously extracted set of a data records must be retransmitted, in which case the original time of the data records is provided via the DE API. Furthermore, it is advantageous to specify the time in each transmitted data record in the case where a set a data records, each with a different time, is transmitted. This situation may occur when it is necessary to transmit previously omitted data records or to correct previously transmitted erroneous data records, in which cases the corrected data records must be backdated. Specifically, if the Time 330 sub-record is both absent from the data record and not provided via the DE API 210, then it is set by the DE API 210 to the time when the data file was transmitted by a utility data management system 110. Time included in transmitted records or explicitly provided by the DE API 210 is referred to as the effective time of the data record. The time when the data was transmitted to the DE API 210 is referred to as the transaction time of the data record. Thus, if present, the effective time overrides the transaction time.

The ability for datastore 200 to explicitly include time in the data record 310, or via the DE API 210, enables records to be backdated and/or future dated. Using datastore system 200, backdating a record is used to correct a previously transmitted erroneous record, as discussed in further detail below.

In operation, DE API 210 is configured to perform two operation types, a record addition operation (“assert”), and a record retraction operation (“retract”). Accordingly, a normal transaction includes a record 310, an operation type, and an optional effective time parameter where Time 350 sub-record of the record 310 is not present. Each transaction received by the DE API 210 that does not include an effective time is assigned a distinct transaction time which may be used to identify the transaction. The record addition operation adds received data records 310 to the journal index 220. The record retraction operation removes previously added data records 310 from the journal index 200, for example where the added data record is erroneous. The indication of whether a record addition or a record retraction is to be performed is included in the transaction received by analytics system 120 from a consumer information system 110. In one embodiment, retracted records are marked as retracted (Active 364), but are otherwise retained within the journal index 220 for audits, etc. DE API 210 does not include an operation type for modifying a previously added data record. To modify a previously added record, DE API 210 must be used to retract the record and a new, corrected, record may be added. The simplification facilitates maintenance of an audit trail as needed.

In normal transactions, time is an optional parameter in a data record 310, a missing effective time is cured by the assignment of a transaction time by the DE API 210. The exception is for a record 310 to be retracted. Normally, the effective time can be omitted since the data records 310 are asserted periodically, each time reflecting the current state of the sensors providing the record data. However, if an erroneous record needs to be retracted by the DE API 210, the effective time of the erroneous record is included either explicitly in the data file or as an operation parameter. The retraction will necessarily occur after the erroneous record was asserted which implies that the assertion and retraction have different transaction times. Therefore, to match a specific asserted record, the effective time of the asserted records is specified. The effective time of the erroneous record can be determined by querying the journal.

Although specifying transaction time is one exemplary method for specifying records to be retracted, there are many other ways to specify the records to be retracted. For example, a retraction request may specify retraction of all records that have a given transaction time/number, or those that had a given transaction time/number and row number or set of row numbers.

Journal index 220 is a durable record of all the transactions performed via DE API 210. Journal index 220 further provides input data to the history index 240 through history processor 230 as described below and maintains an audit trail for all transactions.

Referring now to FIG. 3B, a table 360 representing an exemplary embodiment of journal index 200 is shown, according to an exemplary embodiment. Journal index 370 is a data file that includes a set of documents, each document including a logical tuple 410 (Time 330, Identifier 340, State 350, Transaction Time 361, Row 362, Operation 363, Active 364) where (Time 330, Identifier 340, State 350) are the sub-records 330-350 for a record 310 as described above included in the logical tuple 380.

Transaction Time sub-record 361 is a transaction time assigned by DE API 210. DE API 210 serializes the receipt of all transactions by assigning a transaction time to each transaction, which will necessarily be in a strictly increasing order. In a preferred embodiment, DE API 210 serializes the assignment of Transaction Time sub-record 361 to each received transaction request and then queues the transaction for asynchronous processing.

Row sub-record 362 is the row number of the record in the data file.

Operation sub-record 363 is the operation type, restricted to either “assert” or “retract” for datastore system 200.

Active sub-record 364 is a Boolean flag that indicates whether the document is active. The value of the flag is computed from the operations sub-record 363. The value “true” indicates that the document is active while the value “false” indicates that the document is not active. When a file is asserted, all of its records with Active set to “true” become documents. If a subsequent transaction retracts (Time, Identifier, State) that the Active sub-record 364 is set to “false”. Since Active sub-record 364 is a computed field, it may be omitted from Journal Index 220 and computed on demand in an alternative embodiment. However, inclusion of the Active sub-record 390 improves clarity and computational efficiency.

History processor 230 computes sensor history from the journal index 220 and stores the history in the history index 240. The history computation includes steps performed for each distinct identifier in journal index 220.

In computing the history, history processor 230 selects all documents from journal index 220 having the given identifier and whose active flag is set to “true”, sorting the selected documents in ascending order using a compound key, (Time, Transaction Time, Row). The compound key provides a deterministic, total, chronological ordering for all of the documents in journal index 220. Since the effective time (the value in Time 330 sub-record) takes precedence over transaction time (Transaction Time 361), records imported in later transactions may be “back-dated” to have a prior effective time. Additionally, records that have the same value in Time 330 sub-record but appear later in the file take precedence over those that appear earlier in the file.

Next, history processor 230 compresses the sorted set of documents by eliminating documents where the value in State 350 sub-record does not change. The result is a history in which each document has a state that differs in some aspect with respect to its immediate predecessor. History processor 230 then stores the documents for the identifier in history index 240 and repeats the history computation for the next unprocessed identifier.

In a preferred embodiment, history processor 230 forward fills missing values in State 350 sub-record as needed. History processor 230 is configured with the set of state field names used by the advanced metering analytics system 120. The initial value of each of the state fields is set to a default value, e.g., an empty string, a distinguished “Not Available” value, etc. As records with given fields are received, their values are set accordingly. However, if a later record omits a field name, history processor 230 forwards the previous value.

History processor 230 distinguishes between the case of a field name being present but having an empty value and the case where the field name is absent. If a field name is present but has an empty value, then the field name is not considered to be missing. Advantageously, treating the present but empty value as not being missing provides a mechanism for deleting previous field values. For example, where advanced metering analytics system 120 uses a field to record telephone extension numbers, including a field name in a record with an empty field value means that the new phone number no longer has an extension. Where this is the case, it would be incorrect to interpret the extension number as missing and forward fill its previous value into the updated phone number extension field.

Using the system 200, any transaction potentially impacts all histories for all sensors and all times since a file may contain records for all sensors and records may be backdated. Therefore, history index 240 is recomputed after every transaction.

In a preferred embodiment, history processor 230 recomputes histories incrementally as follows. History processor 230 is executed at a lower priority than the DE API 210 such that all queued transactions are processed and stored in journal index 220 before any history is recomputed. Next, DE API 210 detects the set of sensors impacted by a transaction, along with their earliest effective time, and queues those (Time, Identifier) pairs for processing by history processor 230. Finally, history processor 230 only recomputes the histories for the queued sensors and does so starting from their queued Time 330 sub-record value since the state at earlier times is not impacted.

History index 240 provides the history of state values changes of each sensor. History index 240 comprises a datastore of documents where each document contains a logical tuple (Time, Identifier, State). As previously described, the documents in history index 240 only include records for which some aspect of the state changed.

Access API 250 provides users and other systems access to journal index 220 and history index 240. These datastores are used by users and other systems for various applications. For example, a billing system 116 that computes water consumption at a premises based on meter readings will typically include a record of meter parameters such as where the meter was installed, information about the meter, such as its resolution at any given point in time, etc. Access to journal index 220 may be used technicians using utility client computers 114 to troubleshoot data issues, e.g., missing, or incorrect data. In an exemplary embodiment, access API 250 is configured to interact with customer information system 110 through analytics system 120.

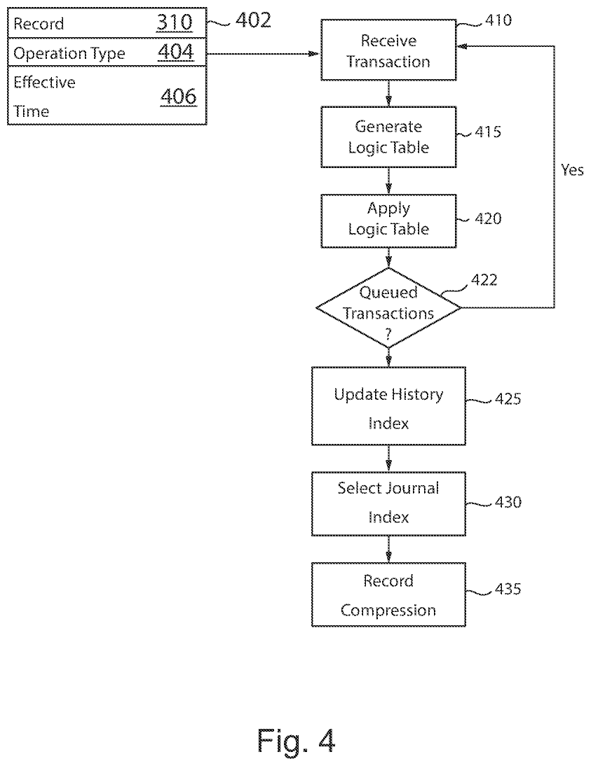

Referring now to FIG. 4, a method for implementing the sensor-centric datastore 200 is shown, according to an exemplary embodiment. The method may be implemented by a computer processor of the analytics system 120 or an independent computer system. The computer system may include a processor configured to implement a computer program stored in nonvolatile memory to implement the functionality described herein.

In a step 410, datastore system 200 receives a transaction 402 from analytics system 120 or another external system. The transaction 402 includes a record 310, an operation type 404, specifically an assertion operation or a retraction operation, and an effective time 406.

In a step 415, DE API 250 generates a logical tuple 410 as described earlier. Accordingly, DE API 250 will combine a received record 310 including the time 330 sub-record, the identifier 340 sub-record, and the state 250 sub-record with generated transaction time 361, row 362, operation 363 (from operation type 404), and active flag 364. As described earlier, the effective time 406 is an optional field that will be populated with a transaction time by DE API 210 if the effective time field 406 is blank.

In a step 420, the generated logical tuple 400 is applied to journal index 220. Application of a logical tuple 400 may include addition of the logic tuple 400 in a new row 362 if the operation 363 is an assert operation. If the operation 363 is a retract operation, application of the logical operation may include removal of a previous logic tuple identified by the logical tuple 400. In an alternative embodiment, application of the logical operation may include modification of the previously asserted record by setting the active flag 364 set to “False” to indicate an inactive record.

In a step 425, history processor 230 is configured to update history index 240 based on the received transactions for each distinct identifier 340 in journal index 220. In a preferred embodiment, history index 240 is recalculated based on each received transaction step 410. However, as previously stated, history processor 230 is executed at a lower priority than DE API 210. Accordingly, all queued received transactions in step 410 are processed prior to implementing step 425. Accordingly, a determination is made in a step 422 whether there any queued transactions remain. If queued transactions remain, steps 410-420 are repeated until there are no remaining queued transactions. If no transactions remain, step 425 is performed to update history index 240 for each unique identifier 340.

In a step 430, updating history index 240 includes selecting all journal index records 310 having the subject unique identifier 340. The selected documents are sorted in ascending order using a compound key (the values of Time 330 sub-record, identifier 340 sub-record and state 350 sub-record). The compound key provides a deterministic, total, chronological ordering of the selected documents from the journal index 220. Using the compound key, the effective time as represented by the value of the time 330 sub-record, takes precedence over the transaction time, as represented by the value of the transaction time 361. Accordingly, records imported in later transactions may be backdated to have a prior effective time. Further, records that have the same values in the time 330 sub-record but appear later in a record sequence 300 take precedence over those that appear earlier.

In a step 435, the selected and sorted journal index records 310 are compressed by eliminating records 310 that do not include a change in the state 350 sub-records in comparison to preceding journal index records. The resultant listing of journal index records 310 having unique state 350 sub-records is a listing in which each document has a state 350 sub-record that differs in some aspect with respect to its immediate predecessor. In a step 440, the resultant listing of journal index records 310 having unique state 350 sub-records is stored in history index 240.

Using the stored sensor description data, the analytics system 120 receives a request from customer information systems 110 to provide sensor information as informed by sensor description data from sensor-centric datastore 200. For example, a system 110 that computes water consumption at a premises from meter readings provides a request that requires data indicative of a premises where the meter is installed and its resolution during a defined time.

This has been a description of exemplary embodiments, but it will be apparent to those of ordinary skill in the art that variations may be made in the details of these specific embodiments without departing from the scope and spirit of the present invention, and that such variations are intended to be encompassed by the following claims.

We claim:

1. A computer-implemented data management system for sensor-centric data management, comprising:
a metering analytics system configured to receive and store meter data received from sensors in or in proximity with utility meters, the meter data being generated by the sensors; and
a sensor-centric database for storing sensor description data for the sensors according to a sensor identifier, the sensor description data describing the sensor associated with the sensor identifier, the database including
a data exchange interface configured to receive a transaction for storage in the sensor-centric database including a record of sensor description data and an “assert” or “retract” operation type.

2. The computer-implemented data management system of claim 1, wherein the transaction further includes an effective time field.

3. The computer-implemented data management system of claim 2, wherein the sensor-centric database is configured to determine that the effective time field is blank and to assign a transaction time to the record of sensor description data.

4. The computer-implemented data management system of claim 1, wherein the sensor-centric database further includes a journal index that store records received through the data exchange interface including both asserted and retracted records.

5. The computer-implemented data management system of claim 1, wherein the sensor-centric database further includes a history index that stores asserted records from the journal index based on their effective or transaction time and the sensor description data is unique between adjacent soiled asserted records.

6. The computer-implemented data management system of claim 5, wherein the sensor description data includes a utility meter parameter for a utility meter installed at a premises.

7. A computer-implemented data management system for sensor-centric data management, comprising:
a metering analytics system configured to receive and store meter data received from sensors in or in proximity with utility meters, the meter data being generated by the sensors; and
a sensor-centric database for asynchronously storing sensor description data transmitted by a utility data management system according to a sensor identifier, the sensor description data describing the sensor associated with the sensor identifier, the database including
a data exchange interface configured to receive a transaction for storage in the sensor-centric database including a record of sensor description data and an “assert” or “retract” operation type,
wherein the sensor description data is utilized by the metering analytics system during communication of the meter data to the utility data management system.

8. The computer-implemented data management system of claim 7, wherein the transaction further includes an effective time field.

9. The computer-implemented data management system of claim 8, wherein the sensor-centric database is configured to determine that the effective time field is blank and to assign a transaction time to the record of sensor description data.

10. The computer-implemented data management system of claim 7, wherein the sensor-centric database further includes a journal index that store records received through the data exchange interface including both asserted and retracted records.

11. The computer-implemented data management system of claim 7, wherein the sensor-centric database further includes a history index that stores asserted records from the journal index based on their effective or transaction time and the sensor description data is unique between adjacent sorted asserted records.

12. The computer-implemented data management system of claim 7, wherein the sensor description data includes a utility meter parameter for a utility meter installed at a premises.
